(19) United States
(12) Patent Application Publication
(10) Pub. No.: US 2026/0249351 A1
(43) Pub. Date: Aug. 27, 2026

(54) METHOD FOR MANUFACTURING FE-XSI(X=4-10.0WT%) ALLOY COMPRESSED POWDER CORE BY HIGH-TEMPERATURE MOLDING

(71) Applicants: FILLIPER INC., Daegu (KR); INDUSTRY ACADEMIC COOPERATION FOUNDATION KEIMYUNG UNIVERSITY, Daegu (KR)

(72) Inventors: Kyu Jin KIM, Sejong-si (KR); Jung Moon PARK, Daegu-si (KR); Seon Bong LEE, Daegu-si (KR)

(73) Assignees: FILLIPER INC., Daegu (KR); INDUSTRY ACADEMIC COOPERATION FOUNDATION KEIMYUNG UNIVERSITY, Daegu (KR)

(21) Appl. No.: 18/994,357

(22) PCT Filed: Jan. 17, 2023
(86) PCT No.: PCT/KR2023/000798

§ 371 Date: Jan. 14, 2025

(30) Foreign Application Priority Data
Jul. 15, 2022 (KR) 10-2022-0087477

(51) Int. Cl. B22F 3/16; B22F 1/102; B22F 1/105; B22F 3/24; C22C 45/02; H01F 41/02

(52) U.S. Cl. CPC B22F 3/16; B22F 1/102; B22F 1/105; B22F 3/24; C22C 45/02; H01F 41/0246; B22F 2003/248; B22F 2301/35

(57) ABSTRACT

The present invention relates to a method for manufacturing a Fe-xSi (x=4-10.0 wt %) alloy compressed powder core by high-temperature molding and a high-temperature molded, Fe-xSi (x=4-10.0 wt %) alloy compressed powder core manufactured by the manufacturing method, the method comprising: (a) a coating step of coating a metal alloy powder with an insulator (coating agent), (b) a lubricant mixing step of mixing a lubricant with the metal alloy powder coated with the insulator (coating agent), (c) a primary molding step of primarily molding the coated metal alloy powder at room temperature, (d) a secondary molding step of secondarily molding the coated metal alloy powder at a high temperature, and (e) a heat treatment step, whereby the alloy compressed powder core is higher in molding density and permeability and lower in iron loss compared to those manufactured by conventional room temperature molding methods.

### CROSS-REFERENCE TO RELATED APPLICATIONS

This application is a 35 U.S.C. § 371 national phase of PCT International Application No. PCT/KR2023/000798, filed Jan. 17, 2023, which claims the benefit of priority under 35 U.S.C. § 119 to Korean Patent Application No. 10-2022-0087477, filed Jul. 15, 2022, the content of which is incorporated herein by reference in its entirety.

### FIELD

The present disclosure relates to a method for manufacturing an Fe-xSi (x=4-10.0 wt %) alloy compressed powder core with a high molding density and permeability and a low iron loss compared to conventional room temperature molding methods, and an Fe-xSi (x=4-10.0 wt %) alloy compressed powder core manufactured by high-temperature molding using the same method.

### BACKGROUND

As the Si content of Fe-xSi (x=4-10.0 wt %) alloy powder increases, the ductility decreases linearly, and when the Si content exceeds 3.5 wt %, surface cracks occur during rolling at room temperature, and it is very difficult to exceed 80% of the true density even during powder molding. Therefore, it is difficult for a compressed powder core molded at room temperature to have an effective permeability exceeding 60, and the iron loss value is also very high, making it difficult to apply to high-current components of electric vehicles, solar power, and the like.

In the related arts regarding a method for manufacturing a compressed powder core, Korean Patent No. 10-1640559 (registered on Jul. 12, 2016) discloses a technique for manufacturing a magnetic powder paste, comprising the following steps: (i) preparing an organic vehicle by uniformly stirring a polymer resin for a predetermined period of time, considering properties of a magnetic core and workability of paste (s10); (ii) cleaning and polishing surface of particles of the magnetic powder by treating the magnetic powder with phosphate, and adding the phosphate-treated magnetic powder to the organic vehicle (s20); and (iii) roll-mixing milling the magnetic powder with the organic vehicle (s30), and in step (ii), the magnetic powder is added with a composition ratio of 50 wt % to 97 wt % of the magnetic powder and 3 wt % to 50 wt % of the organic vehicle.

In addition, Korean Patent No. 10-1499297 (registered on Feb. 27, 2015) discloses a technique for manufacturing an amorphous and nanocrystalline alloy compressed powder core with excellent high-frequency characteristics, an effective permeability of 85 or higher at 100 KHz, and very low iron loss (300 mW/cc or less at 50 KHz, 0.1 T), the method which involves performing double coating with an inter-particle insulating agent using phosphate coating and polyimide-based materials, and utilizing MoS₂ or graphite powder, which enables powder lubrication at high temperatures, to carry out automatic compression molding at 200 to 550° C.

In addition, Korean Patent No. 10-160483 (registered on Mar. 24, 2016) discloses a technique for manufacturing a nanocrystalline compressed powder core with an effective permeability of 150 or higher at 100 kHz, which was not achievable using conventional room-temperature molding methods, the method which involves using powder with a saturation flux density of 1.5 T or higher, produced through high-pressure water atomization and rapid solidification, and manufacturing a compressed powder core through warm compaction to achieve an iron loss of 300 mW/cc or less under conditions of 50 KHz and 1000 Gauss.

In addition, Korean Patent Application Publication No. 10-2018-0034682 (published on Mar. 8, 2018) discloses a technology related to an Fe-based soft magnetic alloy, and more specifically, to an Fe-based soft magnetic alloy with a high saturation flux density suitable for a miniaturized and lightweight component, and a magnetic component that exhibits excellent magnetic performance with a low magnetic loss.

### SUMMARY

As can be seen from the above prior literatures, molding at a high temperature of 400° C. or higher compared to room temperature results in a significant increase in molding density. However, since a molding temperature must be increased, a lubricant and insulating agent that can withstand high temperatures are required, and since the insulating coating agent softens, powder fillings becomes uneven, resulting in an uneven weight of a compressed powder core, which results in uneven magnetic properties.

In order to solve the above problem, the present disclosure aims to coat Fe-xSi (x=4-10.0 wt %) alloy powder with an insulating agent for enhanced insulation and bonding properties, followed by mixing the insulating-agent-coated alloy powder with a metal oxide-based lubricant that maintains lubricity at a high temperature to prepare molding powder, which is then subjected to primary molding in a mold designed and manufactured to form a smaller size than a final component at room temperature, enabling easy charging into a final secondary mold.

In addition, the present disclosure also aims to insert a primary molded core into a secondary mold maintained at a temperature of 400° C. or higher, perform secondary molding to achieve a compressed powder core with a density of 6.6 g/cc or higher and a true density of 90% or more, and manufacture a compressed powder core with an improved effective permeability and a reduced iron loss through automated molding technology.

In addition, the present disclosure also aims to manufacture an Fe-xSi (x=4-10.0 wt %) compressed powder core with a high molding density, no surface cracks, excellent inter-particle insulation, low frequency dependence, and stable high permeability even in high-frequency ranges.

To solve the above problems, the present disclosure relates to [1] a method for manufacturing Fe-xSi (x=4-10.0 wt %) alloy compressed powder core through high-temperature molding, the method including: (a) a coating step of coating metal alloy powder with an insulating agent (coating agent); (b) a lubricant mixing step of mixing a lubricant into the metal alloy powder coated with the insulating agent (coating agent); (c) a primary molding step of primarily mold the coated metal alloy powder at room temperature; (d) a secondary molding step of secondarily mold the coated metal alloy powder at a high temperature; and (e) a heat treatment step.

In addition, the present disclosure relates to the method for manufacturing an Fe-xSi (x=4-10.0 wt %) alloy compressed powder core by high-temperature molding, characterized in that in the above [1], [2] the metal alloy powder is an Fe-xSi (x=4-10 wt %) alloy or Fe-10 wt % Si-6 wt % Al alloy (Sendust), which exhibits high brittleness and hardness and is unable to achieve a molding density of 80% or higher during a molding process.

In addition, the present disclosure relates to the method for manufacturing an Fe-xSi (x=4-10.0 wt %) alloy compressed powder core by high-temperature molding, characterized in that in the above [1], [3] in the (b) coating step of coating the metal alloy powder with the insulating agent (coating agent), the coating agent comprises at least one of polyimide, phenol, polysilazane, and phosphoric acid (H3PO4), and an amount of the coating agent is 0.5 to 3.0 wt % of a total mass.

In addition, the present disclosure relates to a method for manufacturing an Fe-xSi (x=4-10.0 wt %) alloy compressed powder core by high-temperature molding, characterized in that in the above [1], [4] in the (c) lubricant mixing step of mixing the lubricant into the metal alloy powder coated with the insulating agent (coating agent), the lubricant comprises at least one of MoS₂ or graphite powder, an average particle size of powder of the lubricant is 1 to 10 μm, and an amount of lubricant is 0.5 to 2.0 wt % of a total mass.

In addition, the present disclosure relates to the method for manufacturing an Fe-xSi (x=4-10.0 wt %) alloy compressed powder core by high-temperature molding, characterized in that in the above [1], [5] in the (c) primary molding step of primarily molding the coated amorphous metal alloy powder at room temperature, a molding pressure is in a range of 12 to 25 tons/cm2, and in the (d) secondary molding step of secondarily molding the coated amorphous metal alloy powder at a high temperature, a molding temperature is in a range of 400 to 700° C. and a molding pressure is in a range of 12 to 25 tons/cm2, and inner and outer diameters of a mold in the primary molding step are formed to be 2 to 7% larger than inner and outer diameters of a mold in the secondary molding step.

In addition, the present disclosure relates to a method for manufacturing an Fe-xSi (x=4-10.0 wt %) alloy compressed powder core by high-temperature molding, characterized in that in the above [1], [6] the (e) heat treatment step is performed at a temperature of 700 to 900° C., which is a temperature where recrystallization of the metal alloy powder takes place without causing sintering, and a heat treatment atmosphere is an inert gas or reducing gas atmosphere, and a heat treatment period is 30 to 120 minutes.

In addition, the present disclosure relates to [7] an Fe-xSi (x=4-10.0 wt %) alloy powder core manufactured by high-temperature molding using the method for manufacturing a compressed powder core according to any one of the above [1] to [6].

In the present disclosure configured as above, it is possible to economically and continuously manufacture an Fe-xSi (x=4-10.0 wt %) compressed powder core with a reduced occurrence of cracks through dual molding processes conducted at room temperature and a high temperature, achieving a molding density of 6.6 g/cm3 and effective permeability of 90 or more, which was previously unattainable through single molding at room temperature.

### BRIEF DESCRIPTION OF THE DRAWING

FIG. 1 is a diagram illustrating a process of manufacturing a compressed powder core according to the present disclosure.

### DETAILED DESCRIPTION

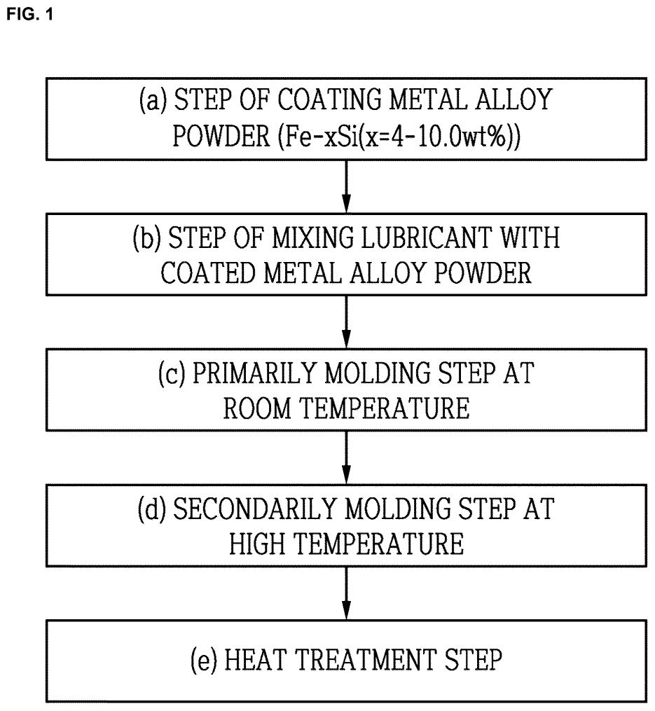

The present disclosure, as shown in FIG. 1, includes: (a) a coating step of coating Fe-xSi (x=4-10.0 wt %) powder with an insulating agent (coating agent), (b) a lubricant mixing step of mixing a lubricant into the Fe-xSi (x=4-10.0 wt %) powder coated with the insulating agent (coating agent), (c) a primary molding step of primarily mold the coated Fe-xSi (x=4-10.0 wt %) powder at room temperature, (d) a secondary molding step of secondarily mold the coated Fe-xSi (x=4-10.0 wt %) powder at high temperature, and (e) a heat treatment step, and each of the aforementioned steps will be described in detail below.

### [(a) Coating Step]

The Fe-xSi (x=4-10 wt %) alloy powder in the present disclosure may be manufactured by mechanical alloying, rapid solidification, water atomization, gas atomization, or the like.

When an Si content is less than 4 wt %, a loss value is high, and when the Si content exceeds 10 wt %, a saturation magnetic flux density decreases to 1.7 T or less and an iron loss also slightly increases. Therefore, in the present disclosure, the Si content is limited as described above.

However, in the present disclosure, in addition to the Fe-xSi (x=4-10 wt %) alloy powder, materials such as Sendust (Fe—SiAl alloy), which exhibits high brittleness and hardness and thus is challenging to achieve a molding density of 80% or higher during a molding process, may also be applied.

The (a) coating step of the present disclosure is to coat an insulating agent (coating agent) on the alloy powder in order to enhance insulation properties and bonding strength during molding of the Fe-xSi (x=4-10 wt %) alloy powder.

In the coating step, the coating agent should have a softening point lower than a heat treatment temperature of the Fe-xSi (x=4-10 wt %) alloy powder to provide insulation and bonding strength during a molding process, and also should exhibit adequate bonding strength at temperatures ranging from 200° C. to 800° C. while maintaining the shape of the compressed powder core under a molding pressure and suppressing the occurrence of cracks.

Polysilazane, phosphoric acid, polyimide, and the like are preferable as a suitable insulating agent (coating agent). In addition, phosphoric acid, polysilazane, and the like may also be applied.

It is preferable to limit an amount of the coating agent to 0.5 to 3.0 wt % of a total mass.

When the coating agent is less than 0.5 wt %, the bonding strength is insufficient, making it difficult to bulkify the Fe-xSi (x=4-10 wt %) alloy powder, and when the coating agent exceeds 3.0 wt %, the inter-particle bonding strength of the Fe-xSi (x=4-10 wt %) alloy powder increases but the amount of Fe-xSi (x=4-10 wt %) alloy powder in a molded body decreases, leading to a deterioration in soft magnetic properties.

The aforementioned total mass refers to the mass of the Fe-xSi (x=4-10 wt %) alloy powder and coating agent that constitute a manufactured compressed powder core.

### [(b) Lubricant Mixing Step]

The (b) lubricant mixing step of the present disclosure is a step of mixing a lubricant into the Fe-xSi (x=4-10 wt %) alloy powder coated with the insulating agent (coating agent) in the (a) coating step.

In order to provide high-temperature lubricity to the Fe-xSi (x=4-10 wt %) alloy powder manufactured by mixing the aforementioned insulating agent (coating agent), MoS₂ or graphite powder is preferable, and an average powder particle size of the lubricant is preferably about 1 to 10 μm.

At this point, it is preferable to limit an amount of lubricant to 0.5 to 2.0 wt % of a total mass. When the amount of lubricant is less than 0.5 wt %, lubricity between powder particles is lacking, which causes damage to a molding punch, and when the amount of lubricant exceeds 2.0%, deteriorated soft magnetic properties and reduced cost efficiency occur.

### [(c) Primary Molding Step]

The (c) primary molding step of the present disclosure is a step of primarily mold the Fe-xSi (x=4-10 wt %) alloy powder coated with the insulating agent (coating agent), and mixed with the lubricant in the (b) lubricant mixing step.

The molding of the Fe-xSi (x=4-10 wt %) alloy powder of the present disclosure is performed in two stages.

In the aforementioned (c) primary molding step, molding is performed at room temperature, and a molding pressure is in the range of 12 to 25 tons/cm2.

In addition, it is preferable that a primary mold used in the primary molding step be smaller than a secondary mold so that a primary molded core can be easily inserted into the secondary mold in the (d) secondary molding step described below.

At this point, it is preferable that an outer diameter of the primary mold in the primary molding step be 2 to 7% smaller than an outer diameter of the secondary mold. If the outer diameter of the primary mold is less than 2% smaller than the outer diameter of the secondary mold, it is not easy to insert the primary molded core into the secondary mold, and if the outer diameter of the primary mold is more than 7% smaller, surface cracks may occur during secondary molding and a molding density decreases.

Meanwhile, it is preferable that an inner diameter of the primary mold, contrary to the outer diameter, is 2 to 7% larger than an inner diameter of the secondary mold. If the inner diameter of the primary mold is less than 2% smaller than the inner diameter of the secondary mold, it is not easy to insert the primary molded core into the secondary mold, and if the inner diameter of the primary mold is more than 7% smaller, surface cracks may occur during secondary molding and a molding density decreases.

### [(d) Secondary Molding Step]

The (d) secondary molding step of the present disclosure is a step of secondarily mold the primary molded core that is molded in the (c) primary molding step.

In the above (d) secondary molding step, molding is performed by inserting the primary molded core into the secondary mold, and at this point, a molding temperature is set within a high-temperature range of 400 to 700° C., and a molding pressure is within a range of 12 to 25 tons/cm².

At this point, if the molding temperature is lower than 400° C., a molding density of 6.6 g/cm3 or higher cannot be achieved, and if the molding temperature exceeds 700° C., the lifespan of the mold is significantly reduced, potentially leading to mold damage.

Meanwhile, if the molding pressure is less than 12 tons/cm2, a molding density of 6.0 g/cm3 or higher cannot be achieved, and if the molding pressure exceeds 25 tons/cm2, the lifespan of the mold significantly reduced, potentially leading to mold damage.

### [(e) Heat Treatment Step]

The (e) heat treatment step of the present disclosure is a step of performing heat treatment on the secondary molded core that is molded in the (d) secondary molding step.

A heat treatment temperature for the secondary molded core should be a temperature where decomposition and sintering of the Fe-xSi (x=4-10 wt %) insulator do not take place, and the heat treatment temperature is preferably in the range of 700 to 900° C. If the heat treatment is performed at a temperature lower than 700° C., sufficient recrystallization of the structure is not achieved, and if the heat treatment is performed at a temperature higher than 900° C., sintering between powder particles may take place.

It is preferable that a heat treatment atmosphere be an inert gas or reducing gas atmosphere, and that a heat treatment period be approximately 30 to 60 minutes. If the heat treatment period is too short, sufficient stress relief and crystallization are not achieved, and if the heat treatment period is too long, productivity decreases.

Hereinafter, the present disclosure will be described based on more detailed examples. However, the present disclosure is not limited to the embodiments described below.

### Example 1

1000 g of Fe-6.5 wt % Si alloy powder (with an average particle size of approximately 25 μm) manufactured by high-pressure water atomization was coated with a solution prepared by dissolving 20 g of polyimide in methylene chloride, and then dried to produce composite particle powder where polyimide was evenly coated on the surface of the Fe-6.5 wt % Si alloy powder with an average particle size of 15 μm, and the dried composite particle powder was then uniformly mixed with 10 g of MoS₂ powder with an average particle size of 3 μm.

The mixed composite particle powder was automatically charged into a mold die with an outer diameter of 12.45 mm and an inner diameter of 7.77 mm, adjusted to be 2% smaller than those of the secondary mold, at approximately 2.50 g at room temperature, and the powder was then molded at a pressure of 18 tons/cm2 with a speed of 10 strokes per minute to manufacture a primary molded core.

The primary molded core was inserted into a mold die with an outer diameter of 12.7 mm and an inner diameter of 7.65 mm and maintained at 600° C., and then charged at a speed of 10 strokes per minute at a pressure of 18 tons/cm2 to manufacture a secondary molded core.

The secondary molded core was heat-treated at 800° C. for 30 minutes in a nitrogen (N₂) gas atmosphere to manufacture a final compressed powder core.

The characteristics such as the density, crack presence, and effective permeability at various frequency ranges measured for the manufactured compressed powder core are shown in Table 1.

The density of the compressed powder core was calculated by dividing the weight of the compressed powder core by the volume of the compressed powder core; crack presence was determined when one or more cracks were observed out of ten manufactured cores; and the effective permeability was measured using an LCR meter under an external magnetic field of 10 mOe for each frequency range.

### Example 2

The procedure was carried out in the same manner as in Example 1, except that the size of the primary mold was set to an outer diameter of 11.81 mm and an inner diameter of 7.09 mm, with a tolerance of 7% relative to the outer and inner diameters of the secondary mold.

The characteristics of the manufactured compressed powder core are shown in Table 1.

### Example 3

The procedure was carried out in the same manner as in Example 1, except that a molding temperature during secondary molding was set to 400° C.

The characteristics of the manufactured compressed core are shown in Table 1.

### Example 4

The procedure was carried out in the same manner as in Example 1, except that Fe-10 wt % Si-6 wt % Al (Sendust) alloy powder (with an average particle size of approximately 30 μm), manufactured by high-pressure water atomization, was used and heat treatment was performed at a temperature of 750° C.

The characteristics of the manufactured compressed powder core are shown in Table 1.

Hereinafter, comparative examples of the present disclosure will be described.

### Comparative Example 1

The procedure was carried out in the same manner as in Example 1, except that the size of the primary mold was set to an outer diameter of 12.51 mm and an inner diameter of 7.51 mm, with a tolerance of 1.5% relative to the outer and inner diameters of the secondary mold.

The characteristics of the manufactured compressed powder core are shown in Table 1.

### Comparative Example 2

The procedure was carried out in the same manner as in Example 1, except that the size of the primary mold was set to an outer diameter of 11.68 mm and an inner diameter of 7.01 mm, with a tolerance of 8% relative to the outer and inner diameters of the secondary mold.

The characteristics of the manufactured compressed powder core are shown in Table 1.

### Comparative Example 3

The procedure was carried out in the same manner as in Example 1, except that a molding temperature was set to 300° C. during secondary molding.

The characteristics of the manufactured compressed powder core are shown in Table 1.

TABLE 1

| | | | | | | Whether | | | Saturation |
|---|---|---|---|---|---|---|---|---|---|
| | | Primary | | Secondary | | charged | | | magnetic |
| | | mold size | | molding | | in the | Molding | Effective | flux |
| Condition | Metal | Outer | Inner | temperature | Crack | secondary | density | permeability | density |
| No. | alloys | diameter | diameter | (° C.) | Presence | mold | (g/cm3) | (100 kHz) | (T) |
| Example 1 | 1) | 12.45 | 7.77 | 600 | X | ◯ | 6.81 | 110 | 1.75T |
| Example 2 | 1) | 11.81 | 7.09 | 600 | X | ◯ | 6.76 | 105 | 1.72 |
| Example 3 | 1) | 12.45 | 7.77 | 400 | X | ◯ | 6.52 | 90 | 1.65 |
| Example 4 | 2) | 12.45 | 7.77 | 600 | X | ◯ | 6.55 | 190 | 1.67 |
| Comparative | 1) | 12.51 | 7.51 | 600 | — | X | — | — | — |
| Example 1 | | | | | | | | | |
| Comparative | 1) | 11.68 | 7.01 | 600 | ◯ | ◯ | 6.72 | 105 | 1.70 |
| Example 2 | | | | | | | | | |
| Comparative | 1) | 12.45 | 7.77 | 300 | X | ◯ | 6.40 | 65 | 1.60 |
| Example 3 | | | | | | | | | |

Fe-6.5 wt % Si₂₎ Fe-10 wt % Si-6 wt % Al

Here, referring to Table 1, it can be seen that when the tolerance of the primary mold size relative to the secondary mold is 1.5% or less, charging into the secondary mold becomes difficult, and when the tolerance exceeds 6%, the molding density decreases and a significant number of cracks occur during secondary molding.

When the molding temperature is equal to or less than 400° C., the molding density cannot exceed 6.5 g/cm3, and accordingly, the permeability cannot exceed 90.

Although exemplary embodiments of the present disclosure have been described for illustrative purposes, those having ordinary knowledge in the technical field of the present disclosure will appreciate that various modifications, additions and substitutions are possible, without departing from the scope and spirit of the present disclosure.

Therefore, the protection scope of the present disclosure should be construed based on the accompanying claims, and it should be construed that all of the technical ideas included within the scope equivalent to the claims are included within the right scope of the present disclosure.

What is claimed is:

1. A method for manufacturing Fe-xSi (x=4-10.0 wt %) alloy compressed powder core through high-temperature molding, the method comprising:
a coating step of coating metal alloy powder with an insulating agent as a coating agent;
a lubricant mixing step of mixing a lubricant into the metal alloy powder coated with the insulating agent as a coating agent;
a primary molding step of primarily mold the coated metal alloy powder at room temperature;
a secondary molding step of secondarily mold the coated metal alloy powder at a high temperature, and
a heat treatment step.

2. The method of claim 1, wherein the metal alloy powder is an Fe-xSi (x=4-10 wt %) alloy or Fe-10 wt % Si-6 wt % Al alloy (Sendust), which exhibits high brittleness and hardness and is unable to achieve a molding density of 80% or higher during a molding process.

3. The method of claim 1, wherein in the (b) coating step of coating the metal alloy powder with the insulating agent as a coating agent, the coating agent comprises at least one of polyimide, phenol, polysilazane, and phosphoric acid (H3PO4), and an amount of the coating agent is 0.5 to 3.0 wt % of a total mass.

4. The method of claim 1, wherein in the (c) lubricant mixing step of mixing the lubricant into the metal alloy powder coated with the insulating agent as a coating agent, the lubricant comprises at least one of MoS₂ or graphite powder, an average particle size of powder of the lubricant is 1 to 10 μm, and an amount of lubricant is 0.5 to 2.0 wt % of a total mass.

5. The method of claim 1,
wherein in the (c) primary molding step of primarily molding the coated amorphous metal alloy powder at room temperature, a molding pressure is in a range of 12 to 25 tons/cm2,
wherein in the (d) secondary molding step of secondarily molding the coated amorphous metal alloy powder at a high temperature, a molding temperature is in a range of 400 to 700° C., and a molding pressure is in a range of 12 to 25 tons/cm2, and
wherein inner and outer diameters of a mold in the primary molding step are formed to be 2 to 7% larger than inner and outer diameters of a mold in the secondary molding step.

6. The method of claim 1, wherein the (e) heat treatment step is performed at a temperature of 700 to 900° C., which is a temperature where recrystallization of the metal alloy powder takes place without causing sintering, and a heat treatment atmosphere is an inert gas or reducing gas atmosphere, and a heat treatment period is 30 to 120 minutes.

7. An Fe-xSi (x=4-10.0 wt %) alloy powder core manufactured by high-temperature molding using the method for manufacturing a compressed powder core according to claim 1.
